(19) United States
(12) Patent Application Publication
(10) Pub. No.: US 2023/0402971 A1
(43) Pub. Date: Dec. 14, 2023

(54) SPLIT BAND-BASED REVERSELY DIFFERENT LIGHT PATH SOLAR THERMAL COMPOUND DEVICE

(71) Applicant: SOOCHOW UNIVERSITY, Suzhou (CN)

(72) Inventors: Yaohui ZHAN, Suzhou (CN); Xinyuan ZHANG, Suzhou (CN); Xiudong XU, Suzhou (CN); Haoxuan XUN, Suzhou (CN); Jining WANG, Suzhou (CN)

(21) Appl. No.: 18/031,820

(22) PCT Filed: Aug. 15, 2022
(86) PCT No.: PCT/CN2022/112621

§ 371 Date: Apr. 13, 2023

(30) Foreign Application Priority Data
Aug. 17, 2021 (CN) 202110941331.5

(51) Int. Cl. H02S 40/42; F25B 23/00

(52) U.S. Cl. CPC H02S 40/42; F25B 23/003

(57) ABSTRACT

The present application provides a split band-based reversely different light path (RDLP) solar thermal compound device. The device includes, but not limited to: a split band RDLP component, a mid-infrared radiative cooler, and a sunlight converter. The split band RDLP component is disposed above the mid-infrared radiative cooler and the sunlight converter, and is suspended by using a support, so that the split band RDLP component is kept from contacting with the components below, to prevent heat conduction. A cavity is provided between the mid-infrared radiative cooler and the sunlight converter below. The cavity is provided to prevent heat conduction between the two. Such a design implements the simultaneous and efficient use of a solar heat source and a radiative cooling source.

### FIELD OF THE INVENTION

The present application belongs to the field of optics and thermal physics, and relates to a split band-based reversely different light path (RDLP) solar thermal compound device.

### DESCRIPTION OF THE RELATED ART

Radiative cooling is a form of refrigeration that uses the intrinsic thermal radiation of an object to reduce the temperature of the object below ambient temperature without any energy input. Any object with a temperature above absolute zero will spontaneously radiate electromagnetic radiation to the outside world. It has been a hot topic of research in recent years due to its environment-friendly zero-emission characteristics.

Two basic requirements need to be met for the implementation of radiative cooling technology.
(1) A radiative cooling film needs to have a reflectivity close to unit 1 for energy of a solar band (300 nm to 2500 nm).
(2) The radiative cooling film needs to have an emissivity close to unit 1 in an atmospheric window band (8 μm to 14 μm).

In practice, the radiative cooling film can be made into a cooling film such as a reflective radiative cooling film disclosed in the Chinese utility model patent No. CN209685670U, titled “Reflective radiative cooling film”, including a coating layer, a metal layer, a transparent polyester PET layer, a mounting adhesive, and a release protective film that are sequentially disposed. The coating layer includes an organic class acrylic coating and micron spheres. There are many technical solutions of radiative cooling, but all these technical solutions have technical shortcomings such as complex design, difficult preparation, high costs, proneness to light pollution, and low efficiency.

For example, disclosed in the Chinese invention patent No. CN105241081B, titled “Compound parabolic concentrator radiator with daytime heat collection and nighttime radiative cooling functions” is a compound parabolic concentrator radiator with daytime heat collection and nighttime radiative cooling functions includes a box with an open top surface, a compound parabolic collector, a glass tube, and a support. The internal shape of the box is a compound parabolic. The support is disposed around the box. The compound parabolic collector is disposed inside the box. The glass tube is disposed along the center of the bottom of the compound parabolic collector. Two ends of the glass tube are respectively disposed as a water inlet and a water outlet. The water inlet and the water outlet are both in communication with an outer surface of the box. The outer surface of the glass tube is coated with a solar collector and radiative cooling compound coating. The device can only make use of solar energy and radiative cooling in separate periods rather than at the same time.

In another example, disclosed in the Chinese invention patent No. CN110138277B, titled “Temperature difference power generation device based on radiative cooling and efficient absorption of solar energy” is a device relying on solar energy and black body radiative cooling to form a temperature difference for power generation. The device includes a carbon nanoparticle film, a semiconductor temperature difference power generation sheet assembly, a radiative cooling film, a support post disposed below the semiconductor temperature difference power generation sheet assembly and a reflective concentrator reflecting sunlight to a lower surface of the carbon nanoparticle film. The semiconductor temperature difference power generation sheet assembly includes an upper insulating heat-conducting plate I, a semiconductor thermoelectric device, and a lower insulating heat-conducting plate II that are sequentially arranged from top to bottom. A load and a data acquisition instrument are sequentially connected between two ends of the semiconductor thermoelectric device. The radiative cooling film is attached to an upper surface of the upper insulating heat-conducting plate I. The carbon nanoparticle film is attached to a lower surface of the lower insulating heat-conducting plate II. A radiative cooling end of the device achieves lower temperature through radiation heat exchange with outer space, which can be more than ten degrees below the ambient temperature, so that the a larger temperature difference and a higher voltage are formed between the two ends of the semiconductor thermoelectric device, which resolves the problem of smaller heat exchange per unit time between a conventional heat sink and the environment. Although a temperature difference generator in this mode implements the simultaneous use of solar energy and “cold energy” of radiative cooling, the efficiency of the radiative cooling film is low, and large-angle thermal radiation emitted from radiative cooling cannot pass through the atmosphere smoothly, resulting in very small contribution to radiative cooling power.

A scheme of compound use of radiative cooling and solar energy can also be adopted. For example, the article “Radiative cooling of solar cells” published in Optica in 2014 introduces a solar cover panel prepared using silicon dioxide three-dimensional photonic crystals. The panel can enhance an infrared atmospheric window emissivity of the surface under the premise of ensuring light absorption of a solar cell, thereby reducing the operating temperature of the solar cell, enhancing the operating efficiency of the solar cell, and extending the life of the solar cell. Although the temperature of the solar cell in this scheme is lower than that without a radiative cooling film, the overall temperature is still higher than the ambient temperature, and the application scenarios are limited.

In summary, the above listed schemes have the following problems.
1) A conventional solar and radiative cooling compound scheme can only use solar energy and radiative cooling in separate periods, for example, separately use the two during daytime and nighttime, but cannot use the two simultaneously, resulting in low energy conversion efficiency.
2) There are technical shortcomings such as complex design, difficult preparation, high costs, proneness to light pollution, and low efficiency.
3) It is difficult to make good actual use in scenarios such as solar cells.
4) The radiative cooling film has the problem of emission angles. The cooling efficiency in the case of a large emission angle is low. The large-angle thermal radiation emitted from radiative cooling cannot pass through the atmosphere smoothly, resulting in very small contribution to radiative cooling power.

### SUMMARY OF THE INVENTION

To overcome the foregoing deficiencies, an objective of the present application is to resolve the problem that the simultaneous use of a solar heat source and an infrared thermal radiation cooling source cannot be implemented by using a device in a conventional solar and radiative cooling compound scheme.

To achieve the foregoing objective, the technical solutions adopted in the present application are as follows:

A split band-based RDLP solar thermal compound device includes:
a split band RDLP component, a mid-infrared radiative cooler, and a sunlight converter, where
the split band RDLP component is disposed above the mid-infrared radiative cooler and the sunlight converter, and is configured to converge and focus incident sunlight band electromagnetic waves and converge and focus mid-infrared band electromagnetic waves emitted by the mid-infrared radiative cooler, and
a cavity is provided between the mid-infrared radiative cooler and the sunlight converter. The cavity is provided to prevent heat conduction between the two. Such a design implements the simultaneous and efficient use of a solar heat source and a radiative cooling source.

Preferably, the split band-based RDLP solar thermal compound device further includes:
a support, the support being used for fixing the split band RDLP component, and keeping the split band RDLP component from contacting with the mid-infrared radiative cooler and the sunlight converter.

Preferably, the split band RDLP component has a spherical shape, or,
the split band RDLP component has a nonspherical semi-enclosed structure.

Preferably, an overall area of the sunlight converter is smaller than an area of the mid-infrared radiative cooler, and the sunlight converter is disposed in a central region of the mid-infrared radiative cooler. If the area of the mid-infrared radiative cooler is known, the cross-sectional area of the cavity is approximately 10% to 20% of the area of the mid-infrared radiative cooler.

Preferably, the split band RDLP component includes two optical surfaces on an inner side and an outer side, and
a light way of sunlight being propagated from the outer side to the inner side is different from a light way of infrared light being propagated from the inner side to the outer side.

Preferably, a material of the split band RDLP component is selected from the group consisting of zinc selenide, polyethylene, hafnium oxide, barium fluoride, and any combination thereof.

Preferably, the split band RDLP component is selected from a conventional lens, a Fresnel lens or a superlens with a micro-nano structure.

Preferably, the split band RDLP component has a certain transmittance in a full band, and has a focal power in both a solar band and a mid-infrared band.

Preferably, the superlens includes a super surface with the micro-nano structure, and the super surface includes: a base, where an upper surface is provided on one side of the base, and the upper surface is configured to converge and focus the incident sunlight band electromagnetic waves; and a lower surface is provided on the other side opposite to the upper surface, and the lower surface is configured to converge and focus the mid-infrared band electromagnetic waves emitted by the mid-infrared radiative cooler.

Preferably, the sunlight converter is a solar cell or a solar thermal collector.

### Beneficial Effects

Compared with the prior art, in the device in the implementations of the present application, the simultaneous and efficient use of a solar heat source and a radiative cooling source is implemented by using an optical design. A design procedure of radiative cooling is greatly simplified, a reflection performance requirement in a solar spectral band in the design is reduced, and it is only necessary to meet the condition of mid-infrared high emissivity to achieve the objective of radiative cooling. The split band RDLP component converges divergent infrared emission angles, to reduce a distance by which a mid-infrared electromagnetic wave passes through the atmosphere, thereby effectively improving the power of radiative cooling.

### BRIEF DESCRIPTION OF THE DRAWINGS

FIG. 1 is a schematic diagram of a split band-based RDLP solar thermal compound device according to an embodiment of the present application;

FIG. 2 is a schematic diagram of a solar thermal compound device using an infrared lens according to an embodiment of the present application;

FIG. 3 is a schematic diagram of a solar thermal compound device using a super surface structure according to an embodiment of the present application;

FIG. 4 is a schematic diagram of a super surface structure according to an embodiment of the present application; and

FIG. 5 is a schematic cross-sectional view of a bottom of a solar thermal compound device according to an embodiment of the present application.

In the accompanying drawings: 1. split band RDLP component, 2. mid-infrared radiative cooler, 3. sunlight converter, 4. cavity, 5. mid-infrared electromagnetic wave emitted by the mid-infrared radiative cooler, 6. electromagnetic wave in a solar band, 7. infrared lens, 8. support, 9. super surface, 10. upper surface of the super surface, 11. base, and 12. lower surface of the super surface.

### DETAILED DESCRIPTION OF THE PREFERRED EMBODIMENTS

The above solutions are further described below with reference to specific embodiments. It should be understood that these embodiments are intended to describe the present application and are not limited to limit the scope of the present application. The implementation conditions used in the embodiments can be further adjusted as in the specific manufacturer's conditions, and the implementation conditions not indicated are usually those used in routine experiments.

The present application provides a split band-based RDLP solar thermal compound device. The device includes: a split band RDLP component, a mid-infrared radiative cooler, and a sunlight converter. The split band RDLP component is disposed above the mid-infrared radiative cooler and the sunlight converter, and is suspended by using a support, so that the split band RDLP component is kept from contacting with the components below, to prevent heat conduction. A cavity is provided between the mid-infrared radiative cooler and the sunlight converter below to prevent heat conduction between the two. The split band RDLP component may have a spherical shape, or may be designed into a nonspherical semi-enclosed structure as required. The split band RDLP component includes two optical surfaces on an inner side and an outer side. A light way of sunlight being propagated from the outer side to the inner side is different from a light way of infrared light being propagated from the inner side to the outer side. Such a component is referred to as a split band RDLP component. The material of the component may be selected from the group consisting of zinc selenide, polyethylene, hafnium oxide, barium fluoride, and any combination thereof. The type of the component may be a conventional lens, a Fresnel lens or a superlens with a micro-nano structure, and may have a certain transmittance in a full band and have a focal power in two bands (a solar band and a mid-infrared band).

The sunlight converter is a component converting solar energy into thermal energy or electrical energy, and is mainly a solar cell or a solar thermal collector.

The sunlight converter is disposed at the central of the mid-infrared radiative cooler. The area of the sunlight converter needs to cover a sunlight focal point of the split band RDLP component, and has a relatively small overall area. The mid-infrared radiative cooler generally occupies a relatively large area. As a component converting thermal energy into infrared light, the mid-infrared radiative cooler radiates heat thereof to outer space in the form of electromagnetic waves through an atmospheric transparency window, to implement that the temperature of the mid-infrared radiative cooler is lower than ambient temperature.

The split band RDLP component with the semi-enclosed structure completely covers the region above the solar thermal combination components, and is fixed thereon by a support or in another manner with a small gap therebetween to prevent direct heat conduction. The component has an important characteristic of having a focal power for electromagnetic waves in a mid-infrared band and a solar band and having a certain transmittance, so that the electromagnetic waves in the two bands can penetrate the material. Parallel incident sunlight passes through the split band RDLP component to focus on the sunlight converter, to converge original sunlight to focus and irradiate a relatively small region of the solar conversion component, and convert solar energy into energy in another form for output. Because the mid-infrared radiative cooler at the periphery has a relatively high mid-infrared emissivity, infrared radiation emitted by the mid-infrared radiative cooler passes through the split band RDLP component to be collimated and converged in a very small solid angle, so that all thermal radiation can pass through an atmospheric window smoothly, thereby eventually enhancing the effect of radiative cooling.

It needs to specifically noted that because sunlight passes through the split band RDLP component to completely focus in the region of the sunlight converter, there is basically no solar energy in the mid-infrared radiative cooler. Therefore, the design requirement of low absorptivity of the mid-infrared radiative cooler in the solar band can be greatly simplified. Because it is not necessary to shield against solar energy for the mid-infrared radiative cooler and the split band RDLP component has already transferred original solar energy, it is only necessary to achieve the objective of high emissivity in an infrared atmospheric window band. This greatly simplifies the manufacturing of the mid-infrared radiative cooler, and the effect of radiative cooling is not reduced.

Next, the solar thermal compound device provided in the embodiments of the present application is described with reference to the accompanying drawings.

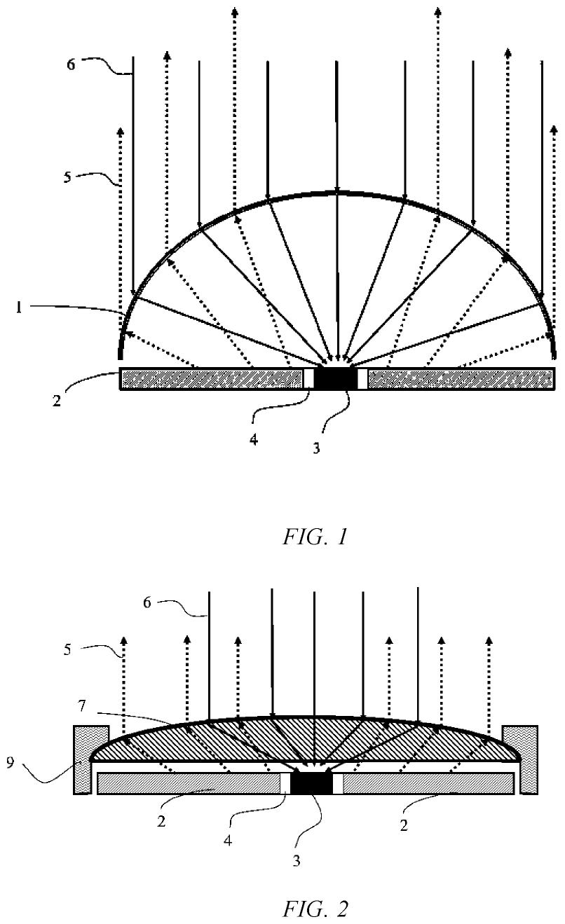

FIG. 1 is a schematic diagram of a split band-based RDLP solar thermal compound device.

The device includes:
a split band RDLP component 1, a mid-infrared radiative cooler 2, and a sunlight converter 3.

The split band RDLP component 1 is disposed above the mid-infrared radiative cooler 2 and the sunlight converter 3, and is suspended by using a support 8, so that the split band RDLP component is kept from contacting with the components below, to prevent heat conduction. A cavity 4 is provided between the mid-infrared radiative cooler 2 and the sunlight converter 3 below the split band RDLP component 1. The cavity 4 prevents heat conduction between the mid-infrared radiative cooler 2 and the sunlight converter 3. In this implementation, the support 8 is kept from contacting with the mid-infrared radiative cooler 2 and prevents heat conduction.

As a variant of the foregoing implementation, angle regulation in two bands is implemented by using an infrared lens 7.

After the compound device is placed on an object that requires temperature reduction, parallel incident electromagnetic waves 6 in the solar band from outside irradiate the device. Light in the solar band is focused into a relatively small range by using the focusing and convergence capability of the lens 2, that is, is focused at the position of the mid-infrared radiative cooler 2 in the lower components. This part of sunlight energy can be used for thermal energy collection and supply, and may be used for electrical energy collection by using a solar cell panel.

After the thermal energy of the object that requires temperature reduction is transferred to the mid-infrared radiative cooler 2, because the mid-infrared radiative cooler has a strong mid-infrared emission capability, the thermal energy is converted into mid-infrared electromagnetic waves and transferred to outer space through an atmospheric window. In this implementation, the lens is made of an infrared material and can converge emission angles of anisotropic radiators to some extent. For the angle convergence, the mid-infrared electromagnetic waves may be propagated to the outer space through the atmospheric window in the form of perpendicular incidence, to reduce the blockage by cloud layers, thereby maximizing the efficiency of radiative cooling. Distances from the infrared lens 7 to the mid-infrared radiative cooler 2 and the cavity 4 below are dependent on the optimal focal length of the lens. The distance between the mid-infrared radiative cooler 2 and the cavity 4 is to avoid contact and prevent heat conduction.

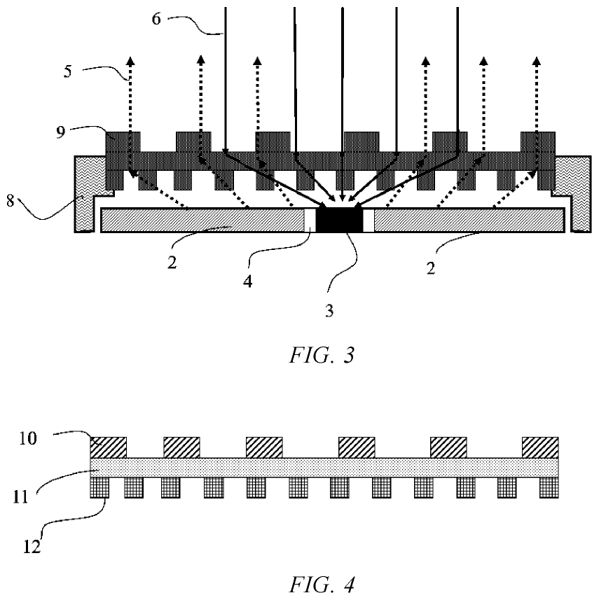

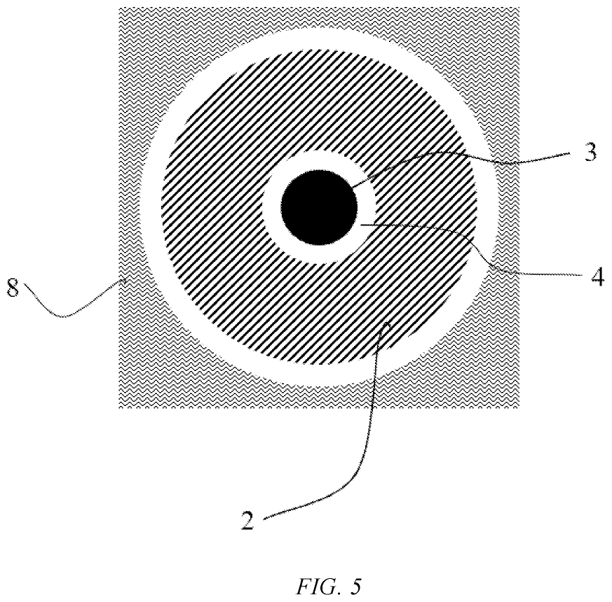

A variant of the implementation in FIG. 1 is shown in FIG. 3 and FIG. 4. In the split band-based RDLP solar thermal compound device, a super surface 9 is used in place of the infrared lens 7. In the scheme in FIG. 1, the infrared lens is used to converge electromagnetic waves in two bands. However, because the ranges of the bands are relatively far from each other, it is very difficult to use a conventional infrared lens to adequately regulate the two bands. Therefore, a superlens (the super surface 9) is used to replace the infrared lens 7. The superlens has a super surface with a micro-nano structure. The super surface is a relatively flexible electromagnetic wave regulation measure with a high degree of design freedom, thereby resolving the problem that it is difficult to use a conventional lens to respectively perform convergence in two bands. An upper surface portion of the super surface converges and focuses the incident sunlight band electromagnetic waves. A lower surface portion of the super surface converges and focuses the mid-infrared band electromagnetic waves emitted by the mid-infrared radiative cooler. In this way, the superlens is used to implement the function of beam focusing and at the same time satisfy the effect of bidirectional two-band light way convergence.

The structure of the (two-sided) super surface is described below with reference to FIG. 4.

The super surface includes: a base 11. An upper surface 10 is configured to on one side of the base 11, and a lower surface 12 is provided on the opposite other side. In the structure, sunlight may first pass through the upper surface 10 of the super surface from above to the structure below. The sunlight may be focused on the sunlight converter below by regulating the phase of the solar band. Mid-infrared electromagnetic waves emitted by the mid-infrared radiative cooler below first pass through the lower surface of the super surface, and achieves the effect of converging emission angles through phase regulation.

As shown in FIG. 5, the support 8 supports the split band RDLP component for suspension thereof. The cavity 4 is provided between the mid-infrared radiative cooler 2 and the sunlight converter 3 to prevent heat conduction between the two.

The foregoing embodiments are only used to describe the technical concept and characteristics of the present application, and are intended to enable a person skilled in the art to understand the content of the present application and achieve implementation, but shall not be used to limit the protection scope of the present application. Any equivalent variations or modifications made according to the spirit and essence of the present application shall fall within the protection scope of the present application.

What is claimed is:

1. A split band-based reversely different light path (RDLP) solar thermal compound device, comprising:
a split band RDLP component, a mid-infrared radiative cooler, and a sunlight converter, wherein
the split band RDLP component is disposed above the mid-infrared radiative cooler and the sunlight converter, and is configured to converge and focus incident sunlight band electromagnetic waves and converge and focus mid-infrared band electromagnetic waves emitted by the mid-infrared radiative cooler, and
a cavity is provided between the mid-infrared radiative cooler and the sunlight converter.

2. The split band-based RDLP solar thermal compound device according to claim 1, further comprising:
a support, the support being used for fixing the split band RDLP component, and keeping the split band RDLP component from contacting with the mid-infrared radiative cooler and the sunlight converter.

3. The split band-based RDLP solar thermal compound device according to claim 1, wherein
the split band RDLP component has a spherical shape, or,
the split band RDLP component has a nonspherical semi-enclosed structure.

4. The split band-based RDLP solar thermal compound device according to claim 1, wherein
an overall area of the sunlight converter is smaller than an area of the mid-infrared radiative cooler, and the sunlight converter is disposed in a central region of the mid-infrared radiative cooler.

5. The split band-based RDLP solar thermal compound device according to claim 1, wherein
the split band RDLP component comprises two optical surfaces on an inner side and an outer side, and
a light way of sunlight being propagated from the outer side to the inner side is different from a light way of infrared light being propagated from the inner side to the outer side.

6. The split band-based RDLP solar thermal compound device according to claim 1, wherein
a material of the split band RDLP component is selected from the group consisting of zinc selenide, polyethylene, hafnium oxide, barium fluoride, and any combination thereof.

7. The split band-based RDLP solar thermal compound device according to claim 1, wherein
the split band RDLP component is selected from a conventional lens, a Fresnel lens or a superlens with a micro-nano structure.

8. The split band-based RDLP solar thermal compound device according to claim 7, wherein
the split band RDLP component has a certain transmittance in a full band, and has a focal power in both a solar band and a mid-infrared band.

9. The split band-based RDLP solar thermal compound device according to claim 7, wherein
the superlens comprises a super surface with the micro-nano structure, and the super surface comprises:
a base,
wherein an upper surface is provided on one side of the base, and the upper surface is configured to converge and focus the incident sunlight band electromagnetic waves; and
a lower surface is provided on the other side opposite to the upper surface, and the lower surface is configured to converge and focus the mid-infrared band electromagnetic waves emitted by the mid-infrared radiative cooler.

10. The split band-based RDLP solar thermal compound device according to claim 1, wherein
the sunlight converter is a solar cell or a solar thermal collector.
